(19) United States
(12) Patent Application Publication
(10) Pub. No.: US 2016/0377827 A1
(43) Pub. Date: Dec. 29, 2016

(54) LENS MODULE AND CAMERA MODULE INCLUDING THE SAME

(71) Applicant: SAMSUNG ELECTRO-MECHANICS CO., LTD., Suwon-si (KR)

(72) Inventors: Young Suk KANG, Suwon-si (KR); Yong Joo JO, Suwon-si (KR); Ick Chan SHIM, Suwon-si (KR)

(73) Assignee: SAMSUNG ELECTRO-MECHANICS CO., LTD., Suwon-si (KR)

(21) Appl. No.: 15/003,896

(22) Filed: Jan. 22, 2016

(30) Foreign Application Priority Data
Jun. 23, 2015 (KR) 10-2015-0089261

(51) Int. Cl. G02B 7/02; G02B 13/00; H04N 5/225; G02B 9/12

(52) U.S. Cl. CPC G02B 7/021; G02B 7/022; G02B 9/12; G02B 13/001; H04N 5/2257; H04N 5/2252

(57) ABSTRACT

A lens module includes a lens barrel comprising a hollow portion; a first lens comprising a lens coupling groove formed in one surface thereof, and an outer peripheral surface contacting an inner peripheral surface of the lens barrel; and a second lens comprising a protrusion portion corresponding to the lens coupling groove, wherein the second lens is stacked on the one surface of the first lens and the protrusion portion inserted into the lens coupling groove.

### CROSS-REFERENCE TO RELATED APPLICATION

This application claims the benefit under 35 USC 119(a) of Korean Patent Application No. 10-2015-0089261 filed on Jun. 23, 2015, with the Korean Intellectual Property Office, the entire disclosure of which is incorporated herein by reference for all purposes.

### BACKGROUND

1. Field

The present disclosure relates to a lens module and a camera module including the same.

2. Description of Related Art

Generally, a compact camera module (CCM), having compact size, has been used in various information technology (IT) apparatuses such as portable mobile communications apparatuses including camera phones, personal digital assistants (PDA), smartphones, toy cameras, and the like. Recently, in accordance consumer preference, the release onto the market of apparatuses in which compact camera modules are mounted, has gradually increased.

Here, lenses included in camera modules are generally manufactured by injection-molding. However, there is a limitation on a thickness of injection-molded lenses, which is disadvantageous in the miniaturization of the camera module.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a lens module includes a lens barrel comprising a hollow portion; a first lens comprising a lens coupling groove formed in one surface thereof, and an outer peripheral surface contacting an inner peripheral surface of the lens barrel; and a second lens comprising a protrusion portion corresponding to the lens coupling groove, wherein the second lens is stacked on the one surface of the first lens and the protrusion portion inserted into the lens coupling groove.

In another general aspect, a camera module includes a lens module including a lens barrel comprising a hollow portion, a first lens comprising a lens coupling groove formed in one surface thereof, and an outer peripheral surface contacting an inner peripheral surface of the lens barrel, and a second lens comprising a protrusion portion corresponding to the lens coupling groove, wherein the second lens is stacked on the one surface of the first lens and the protrusion portion inserted into the lens coupling groove; an image sensor configured to receive light passing through the lens barrel; and a housing, wherein the lens barrel and the image sensor are disposed in the housing.

Other features and aspects will be apparent from the following detailed description, the drawings, and the claims.

### BRIEF DESCRIPTION OF DRAWINGS

FIG. 1 is a cut-away perspective view of a lens module according to one or more embodiments;

FIG. 2 is an exploded perspective view of the lens module according to one or more embodiments;

FIG. 3 is a cross-sectional view of the lens module according to one or more embodiments;

FIG. 4A is a perspective view of a first lens according to one or more embodiments;

FIG. 4B is a bottom perspective view of the first lens according to one or more embodiments;

FIG. 5A is a perspective view of a second lens according to one or more embodiments;

FIG. 5B is a bottom perspective view of the second lens according to one or more embodiments;

FIGS. 6A and 6B are, respectively, a cut-away perspective view and a cross-sectional view illustrating a coupling relationship between the first and second lenses according to one or more embodiments; and

FIG. 7 is a schematic cross-sectional view of a camera module according to one or more embodiments.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Throughout the specification, it will be understood that when an element, such as a layer, region or wafer (substrate), is referred to as being “on,” “connected to,” or “coupled to” another element, it can be directly “on,” “connected to,” or “coupled to” the other element or other elements intervening therebetween may be present. In contrast, when an element is referred to as being “directly on,” “directly connected to,” or “directly coupled to” another element, there may be no elements or layers intervening therebetween. Like numerals refer to like elements throughout. As used herein, the term “and/or” includes any and all combinations of one or more of the associated listed items.

It will be apparent that though the terms first, second, third, etc. may be used herein to describe various members, components, regions, layers and/or sections, these members, components, regions, layers and/or sections should not be limited by these terms. These terms are only used to distinguish one member, component, region, layer or section from another region, layer or section. Thus, a first member, component, region, layer or section discussed below could be termed a second member, component, region, layer or section without departing from the teachings of the exemplary embodiments.

Words describing relative spatial relationships, such as “below”, “beneath”, “under”, “lower”, “bottom”, “above”, “over”, “upper”, “top”, “left”, and “right”, may be used to conveniently describe spatial relationships of one device or elements with other devices or elements. Such words are to be interpreted as encompassing a device oriented as illustrated in the drawings, and in other orientations in use or operation. For example, an example in which a device includes a second layer disposed above a first layer based on the orientation of the device illustrated in the drawings also encompasses the device when the device is flipped upside down in use or operation.

The terminology used herein is for describing particular embodiments only and is not intended to be limiting of the present disclosure. As used herein, the singular forms “a,” “an,” and “the” are intended to include the plural forms as well, unless the context clearly indicates otherwise. It will be further understood that the terms “comprises,” and/or “comprising” when used in this specification, specify the presence of stated features, integers, steps, operations, members, elements, and/or groups thereof, but do not preclude the presence or addition of one or more other features, integers, steps, operations, members, elements, and/or groups thereof.

Hereinafter, embodiments of the present disclosure will be described with reference to schematic views illustrating embodiments of the present inventive concept. In the drawings, for example, due to manufacturing techniques and/or tolerances, modifications of the shape shown may be estimated. Thus, the description should not be construed as being limited to the particular shapes of regions shown herein, for example, to include a change in shape results in manufacturing. The following embodiments may also be constituted by one or a combination thereof.

An optical axis direction refers to a vertical direction in relation to a lens barrel 10.

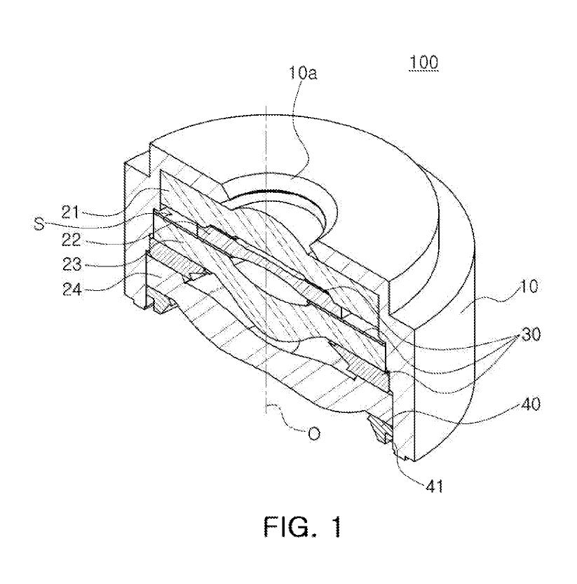

Referring to FIGS. 1 through 3, a lens module 100 includes a lens barrel 10 and a plurality of lenses 21 to 24 disposed in the lens barrel 10 on an optical axis O. The lens barrel 10 has an internal space having a predetermined volume. In other words, a hollow portion in which the lenses are accommodated. The plurality of lenses 21 to 24 imaging a subject are disposed in the internal space. As an example, the lens barrel 10 has a hollow cylindrical shape, and the plurality of lenses 21 to 24 are provided in the lens barrel 10 on the optical axis O.

In addition, a lens hole 10a, for transmission of light, is formed in an upper surface of the lens barrel 10. Hereinafter, a portion of the lens barrel 10 in which the lens hole 10a is formed will be is the ‘object side’ of the lens barrel 10.

The lens barrel 10 may be provided with an actuator (not illustrated) that drive the lenses along the optical axis direction when power is applied thereto. The actuator may have various forms such as a voice coil motor (VCM) using a magnet and a coil and realizing movement of the lenses by electromagnetic force generated by interlinkage between an electric field generated by applying power to the coil and a magnetic field generated in the magnet, a piezo actuator using a piezoelectric body and realizing movement of the lenses by deformation of the piezoelectric body at the time of applying power to the piezoelectric body, and the like.

The plurality of lenses 21 to 24 are stacked and may have optical characteristics such as the same refractive index, or different refractive indices. The number of lenses may be varied depending on the design requirements of the lens module.

The plurality of lenses 21 to 24 are spaced apart from each other at predetermined intervals by spacers 30. The intervals between the plurality of lenses 21 to 24 may be varied depending on the required optical characteristics of the lens module 100. Accordingly, the thickness of the spacers 30 may vary depending on the required intervals between the plurality of lenses 21 to 24.

The shape of spacer 30 corresponds to size and shape of the lens upon which it contacts in order to allow light to be incident on the lens. Thus, the spacer 30 has a hole formed in a central portion thereof so as not to block the light receiving part of the lens from incoming light. Therefore, light incident to the light part of the lens is not obstructed by the spacer 30.

In addition, the spacer is coated with a light shielding material or a light shielding film, in order to prevent unnecessary incident light from being transmitted through the spacer 30. Further, the spacer 30 is formed of an opaque material. For example, the spacer 30 may be formed of a nonferrous metal such as copper (Cu), or aluminum (Al). In this case, the spacer 30 is easily manufactured, and a production cost of the spacer 30 is reduced.

A press-fitting ring 40 is coupled to the outermost side of the plurality of lenses 21 to 24. The press-fitting ring 40 is press-fitted into the lens barrel 10 to prevent the plurality of lenses 21 to 24 from being separated from the lens barrel 10. In one embodiment, the press-fitting ring has a step part 41 formed on a surface not in contact the lenses. An adhesive may be applied to the step part 41 and hardened, so that the press-fitting ring 40 is adhered and fixed to an inner peripheral surface of a lower end of the lens barrel 10.

Although a case in which the lens module 100 includes four lenses has been illustrated in FIGS. 1 through 3, the number of lenses is not limited thereto. The number of lenses may be varied according to the required resolution. Since performance of an optical system including a plurality of lenses is affected by the lenses closest to the object side, a description will be provided below in relation to a first lens, a second lens, and a third lens sequentially disposed from the object side.

For example, a first lens 21 refers to a lens closest to the object side of the lens barrel 10, and a second lens 22 refers to a lens stacked under the first lens 21 on the optical axis O. In addition, a third lens 23 refers to a lens stacked under the second lens 22 on the optical axis O.

Hereinafter, detailed configurations for the plurality of lenses 21 to 24 provided in the lens barrel 10 will be described.

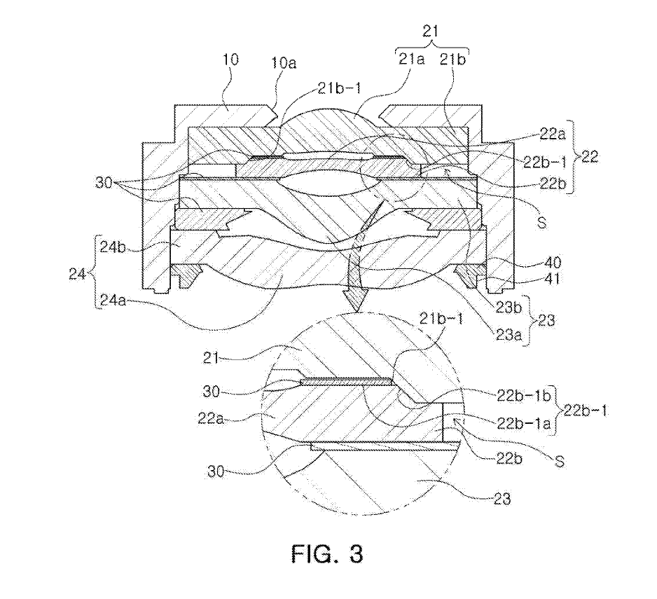

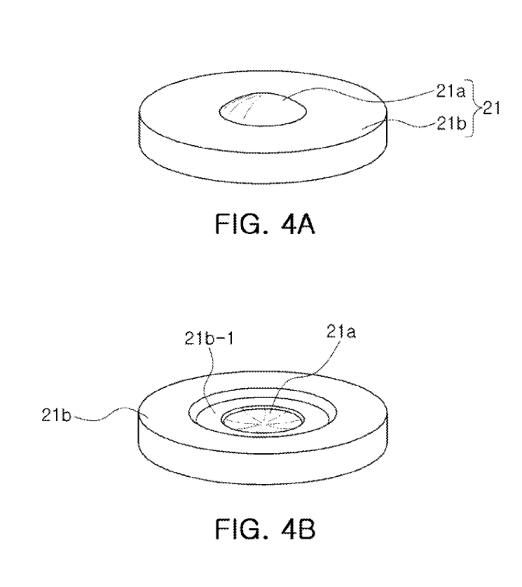

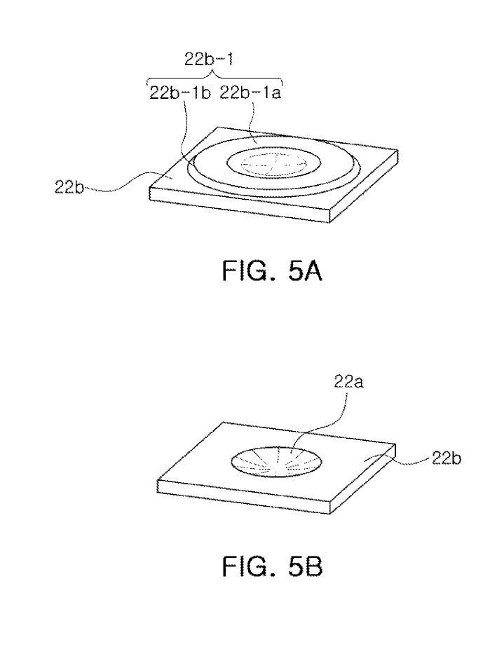

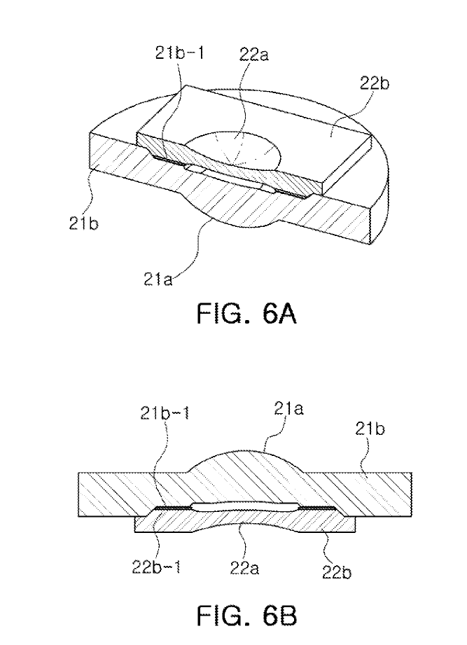

Referring to FIGS. 3 through 6B, first to fourth lenses 21 to 24 may be stacked on the optical axis O within the lens barrel 10. The first to fourth lenses 21 to 24 include optical portions 21a to 24a refracting incident light reflected from a subject, and ribs 21b to 24b extended outwardly from the optical portions 21a to 24a, respectively. Hereinafter, for convenience of explanation, the optical portion 21a and the rib 21b included in the first lens 21 are referred to as a first optical portion 21a and a first rib 21b, respectively, and the optical portion 22a and the rib 22b included in the second lens 22 are referred to as a second optical portion 22a and a second rib 22b, respectively.

The first lens 21 is disposed on the portion of the lens barrel 10 in which the lens hole 10a is formed. In other words, the first lens is disposed on the object side of the lens barrel 10. The first lens 21 is disposed in the lens barrel 10 along on the optical axis.

The first lens 21 includes the first optical portion 21a refracting the incident light reflected from the subject and the first rib 21b extended outwardly from the first optical portion 21a. The first optical portion 21a is exposed to the outside by the lens hole 10a formed in the lens barrel 10, and the first rib 21b contacts an inner surface of the lens barrel 10. In other words, the first lens 21 is fitted into the lens barrel 10.

Referring to FIG. 3, a lens coupling groove 21b-1 depressed inwardly is disposed in one surface of the first rib 21b, and an inner surface of the lens coupling groove 21b-1 is inclined in relation to the optical axis O by a predetermined angle. The lens coupling groove 21b-1 may have a generally circular shape, and the inner surface of the lens coupling groove 21b-1 may be tapered so that a cross-sectional area of the lens coupling groove 21b-1 decreases toward the object side. The first lens 21 may be manufactured by injection-molding.

A second lens 22, is fitted into the lens coupling groove 21b-1. The second lens 22 is stacked on the first lens 21, and includes the second optical portion 22a refracting light passing through the first lens 21, and the second rib 22b extending outwardly, or radially from the second optical portion 22a.

The second lens 22 is stacked on the first lens 21 described above. In detail, the second lens 22 is inserted into and coupled to a surface of the first lens 21 in which the lens coupling groove 21b-1 is formed. To this end, the second rib 22b of the second lens 22 comprises a protrusion portion 22b-1 extending toward the first lens 21 to thereby be inserted into and fixed to the lens coupling groove 21b-1. The protrusion portion 22b-1 has a shape corresponding to that of the lens coupling groove 21b-1, and includes a planar portion 22b-1a contacting a bottom surface of the lens coupling groove 21b-1 and an inclined portion 22b-1b contacting the inner circumferential surface of the lens coupling groove 21b-1.

A depth at which the protrusion portion 22b-1 of the second lens 22 is inserted into the lens coupling groove 21b-1 may be determined by the planar portion 22b-1a, and the first optical portion 21a of the first lens 21 and the second optical portion 22a of the second lens 22 is spaced apart from each other by a predetermined interval. The spacer 30 is provided between the planar portion 22b-1a and the first lens 21.

The protrusion portion 22b-1 is inclined so that a cross-sectional area thereof decreases toward the object side of the lens barrel 10 in order to have the shape corresponding to that of the lens coupling groove 21b-1. The inclined portion 22b-1b of the protrusion portion 22b-1 contacts the inner surface of the lens coupling groove 21b-1. As a result, the second lens 22 may be inserted into and coupled to the first lens 21.

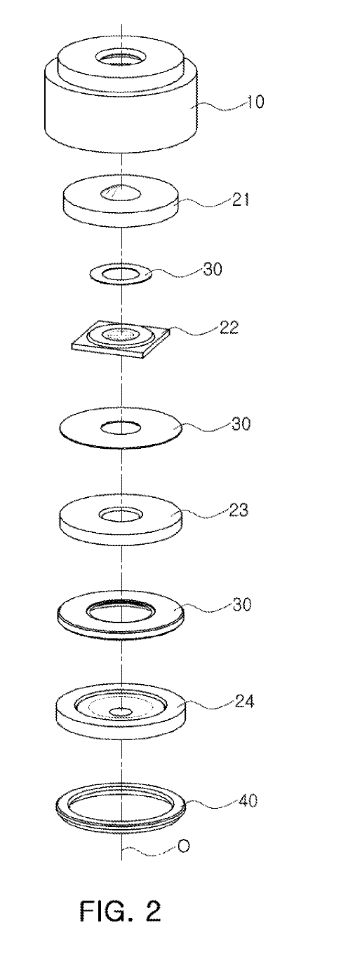

The second rib 22b of the second lens 22 may have a generally quadrangular shape (see FIGS. 2 and 5A-6B), and an outer surface of the second rib 22b is spaced apart from an inner peripheral surface of the lens barrel 10. Since the second lens 22 is coupled to the first lens 21 through the protrusion portion 22b-1, the second lens 22 is not fixed through contact with the inner peripheral surface of the lens barrel 10. Therefore, a space part S is provided between the outer surface of the second lens 22b and the inner peripheral surface of the lens barrel 10. In other words, the second lens 22 may be self-aligned in relation to the first lens 21 by engaging the coupling groove 21b-1 of the first lens 21 with the protrusion portion 22b-1.

The second lens 22 may be manufactured on a wafer level. As an example, the second lens 22 may be manufactured simultaneously by forming a plurality of lenses on a substrate and then cutting the substrate on which the plurality of lenses are formed.

In a case of an injection-molded lens, a minimum thickness of the lens may be about 0.3 mm. However, in a case in which the lens is manufactured on the wafer, the lens may have a thickness of about 0.1 mm. Specifically, the lens may have a thickness of 0.1 mm. Therefore, in the lens module 100 according to an embodiment, the second lens 22 may be manufactured on a wafer.

The third lens 23 is stacked on the other surface of the second lens 22, opposite to the one surface of the second lens facing the first lens 21. A spacer 30 is stacked between the second lens 22 and the third lens 23.

The third lens 23 includes a third optical portion 23a refracting light passing through the second lens 22 and a third rib 23b extended outwardly from the third optical portion 23a. An outer peripheral surface of the third lens 23 contacts the inner peripheral surface of the lens barrel 10. In detail, an outer peripheral surface of the third rib 23b of the third lens 23 contacts the inner peripheral surface of the lens barrel 10. The third lens 23 is stacked on the other surface of the second lens 22 to press the second lens 22 toward the first lens 21, in other words, toward the object side of the lens barrel 10. Therefore, the second lens 22 is fixedly disposed between the first lens 21 and the third lens 23.

The fourth lens 24 is stacked on the third lens 23, and includes a fourth optical portion 24a refracting light passing through the third lens 23 and a fourth rib 24b extended outwardly from the fourth optical portion 24a. The fourth rib 24b of the fourth lens 24 contacts the third lens 23 on one surface thereof, and has the pressing-fitting ring 40 disposed on the other surface thereof. Here, the press-fitting ring 40 presses the fourth lens 40 toward the object side of the lens barrel 10 to prevent the fourth lens 40 from being separated from the lens barrel 10.

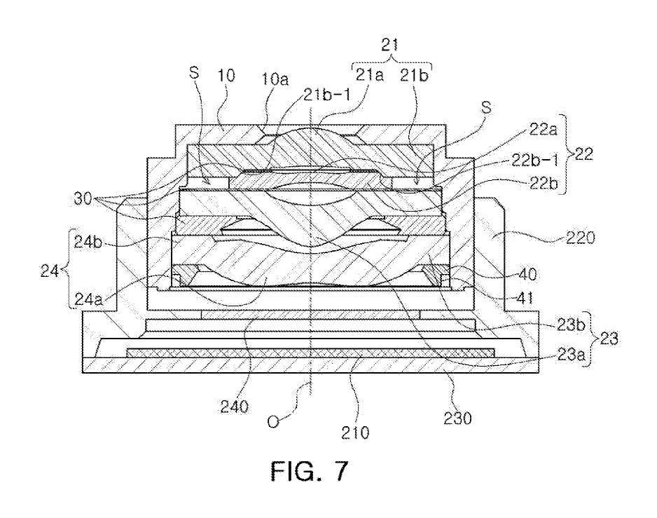

In reference to FIG. 7, the camera module 200 includes the lens module 100, an image sensor 210, and a housing 220. Since the lens module 100 included in the camera module 200 includes all of the components described above, a detailed description therefor will be omitted and replaced by the above-mentioned description.

The image sensor 210 has an image formation region in order to form an image from incident light that passes through the lenses, and converts the light into electrical signals. The image sensor 210 is electrically connected to a board 230 on which a circuit pattern, a means for transmitting an image signal, is printed.

Here, the image sensor 210 is mounted on one surface of the board 230 by a wire bonding method. However, the image sensor 210 and the board 230 are not limited to being electrically connected to each other by the wire bonding method, but may also be electrically connected to each other by various connection methods generally used in the related art.

An optical filter 240 may be an infrared (IR) cut-off filter, or a glass cover. The optical filter is disposed between the image sensor 210 and a lens adjacent to the image sensor 210. It may be considered that the optical filter 240 does not have an influence on optical performance in principle. The optical filter 240 may remove infrared light and only transmit visible light therethrough, thereby preventing a noise phenomenon from occurring in a digital image.

The housing 220 accommodates the lens module 100 and the image sensor 210 therein. The housing 220 encloses an outer portion of the lens module 100. Therefore, the housing 220 forms an exterior of the camera module 200.

As set forth above, the lens module and the camera module including the same according to one or more embodiments is advantageous in miniaturization of a product.

As a non-exhaustive example only, a device or unit as described herein may be a mobile device, such as a cellular phone, a smart phone, a wearable smart device (such as a ring, a watch, a pair of glasses, a bracelet, an ankle bracelet, a belt, a necklace, an earring, a headband, a helmet, or a device embedded in clothing), a portable personal computer (PC) (such as a laptop, a notebook, a subnotebook, a netbook, or an ultra-mobile PC (UMPC), a tablet PC (tablet), a phablet, a personal digital assistant (PDA), a digital camera, a portable game console, an MP3 player, a portable/personal multimedia player (PMP), a handheld e-book, a global positioning system (GPS) navigation device, or a sensor, or a stationary device, such as a desktop PC, a high-definition television (HDTV), a DVD player, a Blu-ray player, a set-top box, or a home appliance, or any other mobile or stationary device capable of wireless or network communication. In one example, a wearable device is a device that is designed to be mountable directly on the body of the user, such as a pair of glasses or a bracelet. In another example, a wearable device is any device that is mounted on the body of the user using an attaching device, such as a smart phone or a tablet attached to the arm of a user using an armband, or hung around the neck of the user using a lanyard.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A lens module comprising:
a lens barrel comprising a hollow portion;
a first lens comprising a lens coupling groove formed in one surface thereof, and an outer peripheral surface contacting an inner peripheral surface of the lens barrel; and
a second lens comprising a protrusion portion corresponding to the lens coupling groove, wherein the second lens is stacked on the one surface of the first lens and the protrusion portion inserted into the lens coupling groove.

2. The lens module of claim 1, wherein the second lens comprises an optical portion, a rib extended radially out from the optical portion, and the protrusion portion protrudes from one surface of the rib facing the first lens.

3. The lens module of claim 2, wherein an outer surface of the rib is spaced apart from the inner peripheral surface of the lens barrel.

4. The lens module of claim 2, wherein the rib has a quadrangular shape.

5. The lens module of claim 2, wherein the protrusion portion includes a planar portion contacting a bottom surface of the lens coupling groove and an inclined portion contacting an inner circumferential surface of the lens coupling groove.

6. The lens module of claim 2, further comprising a third lens stacked on another surface of the second lens.

7. The lens module of claim 6, wherein an outer peripheral surface of the third lens contacts the inner peripheral surface of the lens barrel.

8. The lens module of claim 6, wherein the third lens applies pressure to the second lens toward the first lens.

9. The lens module of claim 1, wherein the second lens is cut from a wafer.

10. The lens module of claim 1, wherein the second lens has a thickness of 0.3 mm or less.

11. The lens module of claim 10, wherein the second lens has a thickness of 0.1 mm.

12. The lens module of claim 1, further comprising at least one lens stacked on the second lens along an optical axis.

13. A camera module comprising:
a lens module comprising:
a lens barrel comprising a hollow portion,
a first lens comprising a lens coupling groove formed in one surface thereof, and an outer peripheral surface contacting an inner peripheral surface of the lens barrel, and
a second lens comprising a protrusion portion corresponding to the lens coupling groove, wherein the second lens is stacked on the one surface of the first lens and the protrusion portion inserted into the lens coupling groove;
an image sensor configured to receive light passing through the lens barrel; and
a housing, wherein the lens barrel and the image sensor are disposed in the housing.

14. The camera module of claim 13, wherein spacers are disposed between the lenses.

15. The camera module of claim 14, wherein the spacers space the lenses apart at a predetermined interval.

16. The camera module of claim 13, wherein the housing includes an optical filter.
